(19) United States
(12) Patent Application Publication
(10) Pub. No.: US 2025/0261788 A1
(43) Pub. Date: Aug. 21, 2025

(54) CHAFING DISH DEVICE

(71) Applicant: Joseph Magana, Phillmore, CA (US)

(72) Inventor: Joseph Magana, Phillmore, CA (US)

(21) Appl. No.: 19/060,019

(22) Filed: Feb. 21, 2025

Related U.S. Application Data
(60) Provisional application No. 63/555,935, filed on Feb. 21, 2024.

(51) Int. Cl. A47J 36/10; A47J 36/24

(52) U.S. Cl. CPC A47J 36/10; A47J 36/24

(57) ABSTRACT

A chafing dish device is disclosed which enhances the convenience and efficiency of transporting and serving prepared liquid foods without spillage. The chafing dish device comprises a base component that is configured in a round shape with a screw-top lid that prevents leaks and spills. The lid can also be comprised of a pressure release and a tight seal. The device can be transported in an insulated stacking crate with handles and tie-down channels. After transport, the base component can be removed from the stacking crate and placed on legs for fuel efficiency and temperature control. The screw-top lid can be replaced with a serving lid during use.

### CROSS-REFERENCE TO RELATED APPLICATION

The present application claims priority to, and the benefit of, U.S. Provisional Application No. 63/555,935, which was filed on Feb. 21, 2024, and is incorporated herein by reference in its entirety.

### FIELD OF THE INVENTION

The present invention relates generally to the field of chafing dish devices. More specifically, the present invention relates to a chafing dish device that allows liquid foods to be easily transported. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in chafing dish devices. Generally, liquid foods are hard to transport from place to place without spillage. Further, moving and serving prepared food is not convenient and prone to spillage. Specifically, liquid foods are hard to transport from place to place without causing a mess. A device that goes seamlessly from prep to presentation is needed.

Further, people who use a chafing dish in a social gathering sometimes use cellophane wrap or some aluminum foil to cover the dish. Unfortunately, these covers often stay open or tear easily, which keeps the food exposed to the elements or contamination from animals. A device that closes easily and prevents food in the chafing dish from being exposed to animals and the elements is needed.

Accordingly, there is a demand for an improved chafing dish device that includes a screw-top to prevents leaks and spills during transportation. More particularly, there is a demand for a chafing dish device that includes insulated stacking crates with handles and tie-down channels for easy and efficient transport.

Therefore, there exists a long felt need in the art for a chafing dish device that provides users with a means for allowing liquid foods to be easily transported. There is also a long felt need in the art for a chafing dish device that includes a screw-top lid to prevent leaks and spills. Further, there is a long felt need in the art for a chafing dish device that comprises a lid with a pressure release. Moreover, there is a long felt need in the art for a device that can be transported via insulated stacking crates with handles and tie-down channels. Further, there is a long felt need in the art for a chafing dish device that utilizes removable aluminum liners for easy cleaning. Finally, there is a long felt need in the art for a chafing dish device that includes legs to enhance fuel efficiency and temperature control.

The subject matter disclosed and claimed herein, in one embodiment thereof, comprises a chafing dish device. The device is a chafing dish designed to enhance the convenience and efficiency of transporting and serving prepared liquid foods without spillage. The chafing dish device comprises a base component that is configured in a round shape with a screw-top lid that prevents leaks and spills. The lid can also be comprised of a pressure release and a tight seal. The device can be transported in an insulated stacking crate with handles and tie-down channels. After transport, the base component can be removed from the stacking crate and placed on legs for fuel efficiency and temperature control. The screw-top lid can be replaced with a serving lid during use.

In this manner, the chafing dish device of the present invention accomplishes all of the forgoing objectives and provides users with a device that allows for easy transport of liquid foods. The device travels seamlessly from prep to presentation. The device can blend with any event décor.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a chafing dish device. The device is a chafing dish designed to enhance the convenience and efficiency of transporting and serving prepared liquid foods without spillage. The chafing dish device comprises a base component that is configured in a round shape with a screw-top lid that prevents leaks and spills. The device can be transported in an insulated stacking crate with handles. After transport, the base component can be removed from the stacking crate and placed on legs, then the screw-top lid can be replaced with a serving lid for use.

In one embodiment, the chafing dish device is designed to make moving and serving prepared food more convenient and less prone to spillage. Liquid foods are hard to transport from place to place without causing a mess. Further, the chafing dish device can be loaded directly from the kitchen into a secure transport system, then can go from van to table within minutes, making it fast and easy to set up serving stations. Thus, the device goes seamlessly from prep to presentation. Further, the chafing dish device provides a clean, professional look, with elegant serving lids that can blend with any event décor.

In one embodiment, the chafing dish device comprises a base component (i.e., chafing dish) that is configured in a round shape with an open interior cavity. The base component can be any suitable shape as is known in the art, such as rectangular, circular, conical, spherical, or any feasible shape desired by a user. The base component may be constructed from at least one of aluminum, wood, plastic, stone, ceramic, closed cell extruded polystyrene foam, etc., but is not limited thereto. Furthermore, the material used to construct the base component may be tempered to improve adaptation to changing temperatures. The base component may be of varying volume, to accommodate different amounts of food. Typically, the base component is large enough to fit up to approximately nine quarts of food.

In one embodiment, the base component comprises a bottom surface, with a curved side wall and an open top surface which allows access to the interior cavity. Further, the curved side wall comprises an upper interior threaded perimeter which mates with the screw-top lid. The base component comprises folding handles for easy transportation, as needed. Typically, a handle would be positioned on either side of the base component side wall and hinges up and down, as needed.

In one embodiment, the base component comprises a screw-top lid that prevents leaks and spills. The lid is sized and shaped to cover the entire open cavity of the base component, when placed on top. Further, the screw-top lid comprises external threads which mate with the internal threads of the base component, to securely seal the lid in place preventing spills from the base component. Further, the screw-top lid comprises a raised component which bisects the top of the lid and creates a handle, allowing a user to easily rotate the lid on and off, as needed. Additionally, the lid can also be comprised of a pressure release valve and a tight seal, to allow pressure to be vented as needed, while keeping the liquid food within the base component from spilling or leaking.

In one embodiment, the chafing dish device comprises an aluminum liner that is sized and shaped to fit within the base component. The aluminum liner is removable for easy cleaning. Further, the aluminum liner is compatible with the screw-top lid.

In one embodiment, the base component and screw-top lid are transported in insulated stacking crates. The stacking crates are typically configured in a cube-like shape with an open interior cylindrical cavity, sized and shaped to retain the base component. Around the cylindrical cavity, the interior is filled with insulating materials which keep the liquid food within the base component hot or cold, depending on the need. Further, the stacking crates include a hinged lid with a seal and latch for easy transport and to prevent spills and leaks. Additionally, the stacking crates have a pair of handles for users to grab during transportation. The stacking crates can be available in different sizes, with some stacking crates sized to retain multiple base components and some stacking crates sized to retain only one base component, depending on need. Further, the stacking crates are sized and shaped to be stacked on each other during transport and storage. Additionally, the stacking crates include tie-down channels on opposing sides, which allow the stacking crates to be tied-down and secured during transportation and storage.

In one embodiment, after transportation the base component and screw-top lid is removed from the stacking crate and positioned on a plurality of legs. The legs are sized and shaped to allow the base component to be nested within and secured, such that each leg is positioned on an exterior side of the base component in a press-fit configuration. Furthermore, the four legs are secured to an elevated section, where the fuel for the base component is positioned. The fuel is typically a combustible substance that heats the liquid food. Accordingly, the legs are sized and shaped to enhance fuel efficiency and provide temperature control for the liquid food within the base component.

In one embodiment, the screw-top lid is replaced with a serving lid. The serving lid is an elegant lid with a clean, professional look that can blend with any event décor. Typically, the serving lid is a domed configuration that secures the base component and keeps the liquid food within hot or cold, as required. The domed configuration comprises a retractable section of the serving lid which can be raised and lowered, as needed to access the liquid food inside the base component.

In one embodiment, the chafing dish device comprises removable inserts and secure lids, allowing the device to be modular and easily transportable. In operation, the liquid food is inserted into the base component and secured with the screw-top lid. The base component with secured lid is then positioned within the insulated crates and transported. Once transported, the base component is positioned on the leg supports at the serving station and the screw-top lid is removed and replaced with the serving lid. Thus, the variable inserts and lids make it fast and easy to set up serving stations and provide elegant serving options that can blend with any event décor.

In yet another embodiment, the chafing dish device comprises a plurality of indicia.

In yet another embodiment, a method of easily transporting liquid food without spills is disclosed. The method includes the steps of providing a chafing dish device comprising a base component with a screw-top lid. The method also comprises screwing the lid onto the base component. Further, the method comprises transporting the base component and lid via insulated crates. The method also comprises removing the base component and placing the base component on the legs. Finally, removing the screw-top lid and replacing it with a serving lid for use.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 and FIG. 2 illustrate a perspective view of one embodiment of the chafing dish device of the present invention in accordance with the disclosed architecture;

FIG. 3 illustrates a perspective view of one embodiment of the chafing dish device of the present invention showing the screw-top lid and serving lid in accordance with the disclosed architecture;

FIG. 4 illustrates a perspective view of one embodiment of the chafing dish device of the present invention showing the different components of the device in accordance with the disclosed architecture;

FIG. 5 illustrates a perspective view of one embodiment of the chafing dish device of the present invention showing the stacking crate with tie-down channels in accordance with the disclosed architecture;

FIGS. 6A, 6B, 6C, 6D illustrate a perspective view of one embodiment of the chafing dish device of the present invention showing the device in use in accordance with the disclosed architecture;

FIG. 7 illustrates a perspective view of one embodiment of the chafing dish device of the present invention showing the device and its components in accordance with the disclosed architecture; and

FIG. 8 illustrates a flowchart showing the method of easily transporting liquid food without spills in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a chafing dish device that provides users with a means for allowing liquid foods to be easily transported. There is also a long felt need in the art for a chafing dish device that includes a screw-top lid to prevent leaks and spills. Further, there is a long felt need in the art for a chafing dish device that comprises a lid with a pressure release. Moreover, there is a long felt need in the art for a device that can be transported via insulated stacking crates with handles and tie-down channels. Further, there is a long felt need in the art for a chafing dish device that utilizes removable aluminum liners for easy cleaning. Finally, there is a long felt need in the art for a chafing dish device that includes legs to enhance fuel efficiency and temperature control.

The present invention, in one exemplary embodiment, is a novel chafing dish device. The chafing dish device comprises a base component that is configured in a round shape with a screw-top lid that prevents leaks and spills. The lid can also be comprised of a pressure release and a tight seal. The device can be transported in an insulated stacking crate with handles and tie-down channels. After transport, the base component can be removed from the stacking crate and placed on legs for fuel efficiency and temperature control. The screw-top lid can be replaced with a serving lid during use. The present invention also includes a novel method of easily transporting liquid food without spills. The method includes the steps of providing a chafing dish device comprising a base component with a screw-top lid. The method also comprises screwing the lid onto the base component. Further, the method comprises transporting the base component and lid via insulated crates. The method also comprises removing the base component and placing the base component on the legs. Finally, removing the screw-top lid and replacing it with a serving lid for use.

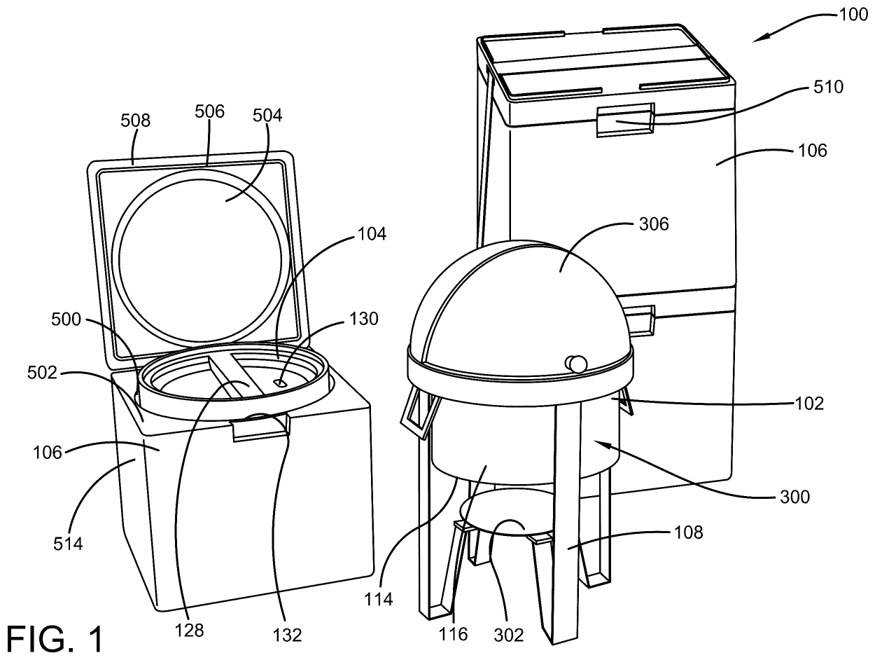

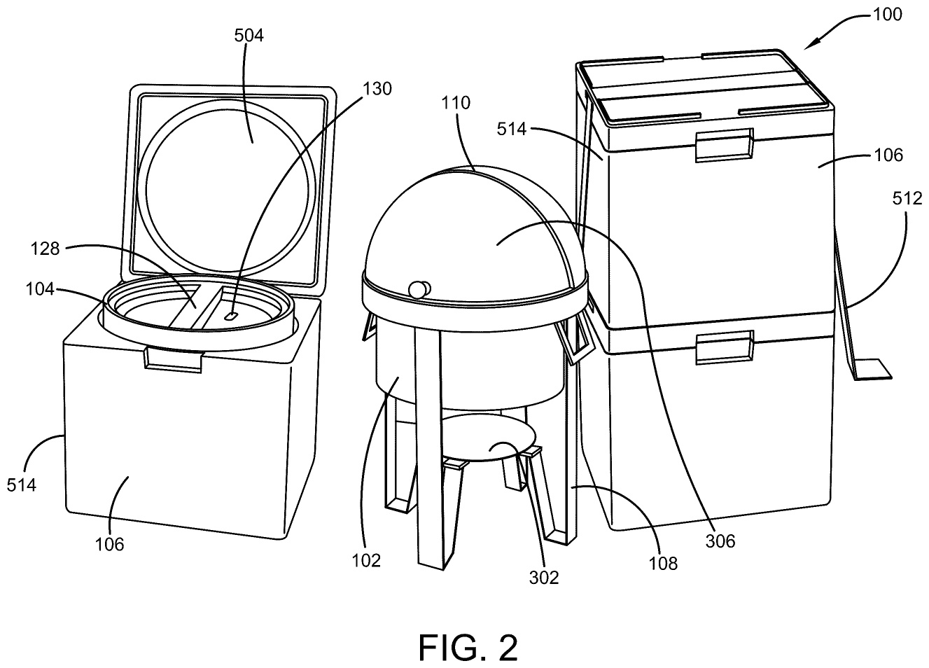

Referring initially to the drawings, FIGS. 1-2 illustrate a perspective view of one embodiment of the chafing dish device 100 of the present invention. In the present embodiment, the chafing dish device 100 is an improved chafing dish device 100 that provides a user with a means for transporting liquid foods without spillage. Specifically, the chafing dish device 100 comprises a base component 102 and a screw-top lid 104 that prevents leaks and spills. The device 100 can be transported in an insulated stacking crate 106. After transport, the base component 102 can be removed from the stacking crate 106 and placed on legs 108, then the screw-top lid 104 can be replaced with a serving lid 110 for use.

Generally, the chafing dish device 100 is designed to make moving and serving prepared food more convenient and less prone to spillage. Liquid foods are hard to transport from place to place without causing a mess. Further, the chafing dish device 100 can be loaded directly from the kitchen into a secure transport system, then can go from van to table within minutes, making it fast and easy to set up serving stations. Thus, the device 100 goes seamlessly from prep to presentation. Further, the chafing dish device 100 provides a clean, professional look, with elegant serving lids 110 that can blend with any event décor.

Further, the chafing dish device 100 comprises a base component 102 (i.e., chafing dish) that is configured in a round shape with an open interior cavity 112. The base component 102 can be any suitable shape as is known in the art, such as rectangular, circular, conical, spherical, or any feasible shape desired by a user. The base component 102 may be constructed from at least one of aluminum, wood, plastic, stone, ceramic, closed cell extruded polystyrene foam, etc., but is not limited thereto. Furthermore, the material used to construct the base component 102 may be tempered to improve adaptation to changing temperatures. The base component 102 may be of varying volume, to accommodate different amounts of food. Typically, the base component 102 is large enough to fit up to approximately nine quarts of food.

Additionally, the base component 102 comprises a bottom surface 114, with a curved side wall 116 and an open top surface 118 which allows access to the interior cavity 112. Further, the curved side wall 116 comprises an upper interior threaded perimeter 120 which mates with the screw-top lid 104. The base component 102 comprises folding handles 122 for easy transportation, as needed. Typically, a handle 122 would be positioned on either side 124 of the base component side wall 116 and hinges up and down, as needed.

Furthermore, the base component 102 comprises a screw-top lid 104 that prevents leaks and spills. The lid 104 is sized and shaped to cover the entire open cavity 112 of the base component 102, when placed on top. Further, the screw-top lid 104 comprises external threads 126 which mate with the internal threads 120 of the base component 102, to securely seal the lid 104 in place preventing spills from the base component 102. Further, the screw-top lid 104 comprises a raised component 128 which bisects the top of the lid 104 and creates a handle, allowing a user to easily rotate the lid 104 on and off, as needed. Additionally, the lid 104 can also be comprised of a pressure release valve 130 and a tight seal 132, to allow pressure to be vented as needed, while keeping the liquid food within the base component 102 from spilling or leaking.

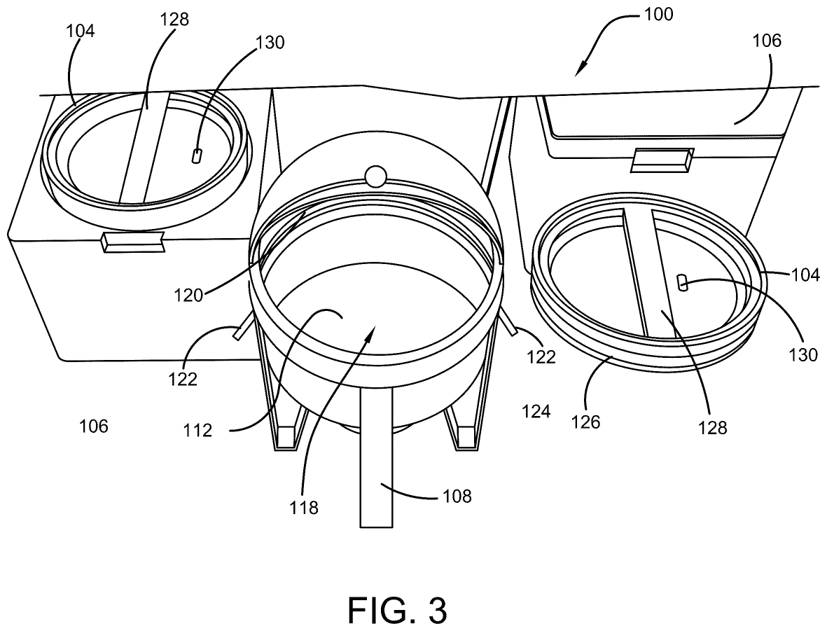

As shown in FIG. 3, after transportation, the base component 102 and screw-top lid 104 is removed from the stacking crate 106 and positioned on a plurality of legs 108. The legs 108 are sized and shaped to allow the base component 102 to be nested within and secured, such that each leg 108 is positioned on an exterior side 300 of the base component 102 in a press-fit configuration. Furthermore, the four legs 108 are secured to an elevated section 302, where the fuel for the base component 102 is positioned. The fuel is typically a combustible substance that heats the liquid food. Accordingly, the legs 108 are sized and shaped to enhance fuel efficiency and provide temperature control for the liquid food within the base component 102.

Further, the screw-top lid 104 is replaced with a serving lid 304. The serving lid 304 is an elegant lid with a clean, professional look that can blend with any event décor. Typically, the serving lid 304 is a domed configuration that secures the base component 102 and keeps the liquid food within hot or cold, as required. The domed configuration comprises a retractable section 306 of the serving lid 304 which can be raised and lowered, as needed to access the liquid food inside the base component 102.

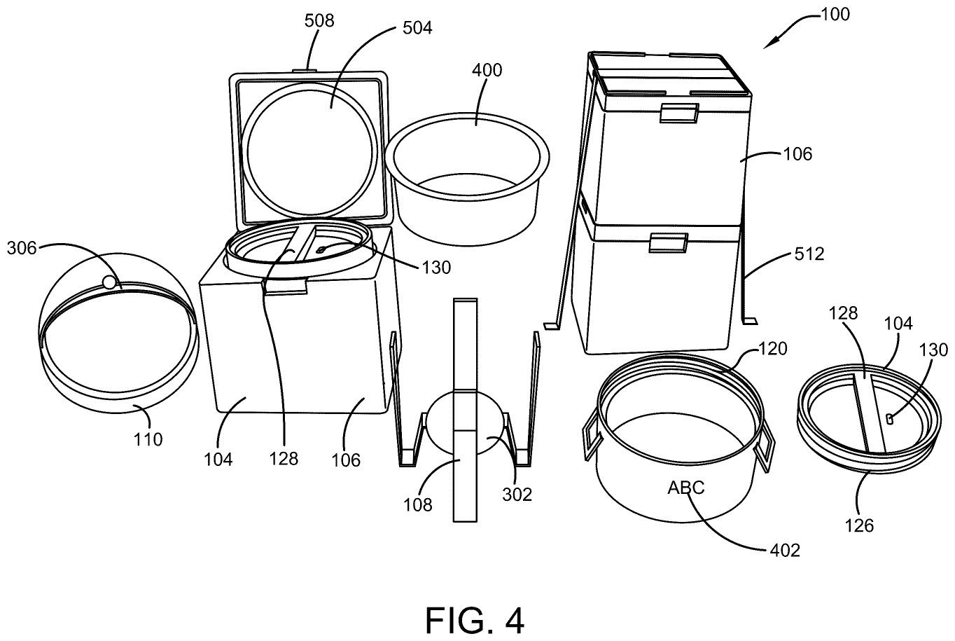

As shown in FIG. 4, the chafing dish device 100 comprises an aluminum liner 400 that is sized and shaped to fit within the base component 102. The aluminum liner 400 is removable for easy cleaning. Further, the aluminum liner 400 is compatible with the screw-top lid 104.

In yet another embodiment, the chafing dish device 100 comprises a plurality of indicia 402. The base component 102 of the device 100 may include advertising, a trademark, or other letters, designs, or characters, printed, painted, stamped, or integrated into the base component 102, or any other indicia 402 as is known in the art. Specifically, any suitable indicia 402 as is known in the art can be included, such as but not limited to, patterns, logos, emblems, images, symbols, designs, letters, words, characters, animals, advertisements, brands, etc., that may or may not be chafing dish, food, or brand related.

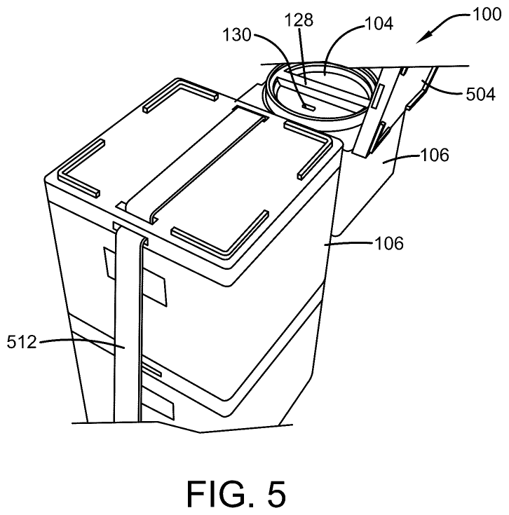

As shown in FIG. 5, the base component 102 and screw-top lid 104 are transported in insulated stacking crates 106. The stacking crates 106 are typically configured in a cube-like shape with an open interior cylindrical cavity 500, sized and shaped to retain the base component 102. Around the cylindrical cavity 500, the interior is filled with insulating materials 502 which keep the liquid food within the base component 102 hot or cold, depending on the need. Further, the stacking crates 106 include a hinged lid 504 with a seal 506 and latch 508 for easy transport and to prevent spills and leaks. Additionally, the stacking crates 106 have a pair of handles 510 for users to grab during transportation. The stacking crates 106 can be available in different sizes, with some stacking crates 106 sized to retain multiple base components 102 and some stacking crates 106 sized to retain only one base component 102, depending on need. Further, the stacking crates 106 are sized and shaped to be stacked on each other during transport and storage. Additionally, the stacking crates 106 include tie-down channels 512 on opposing sides 514, which allow the stacking crates 106 to be tied-down and secured during transportation and storage.

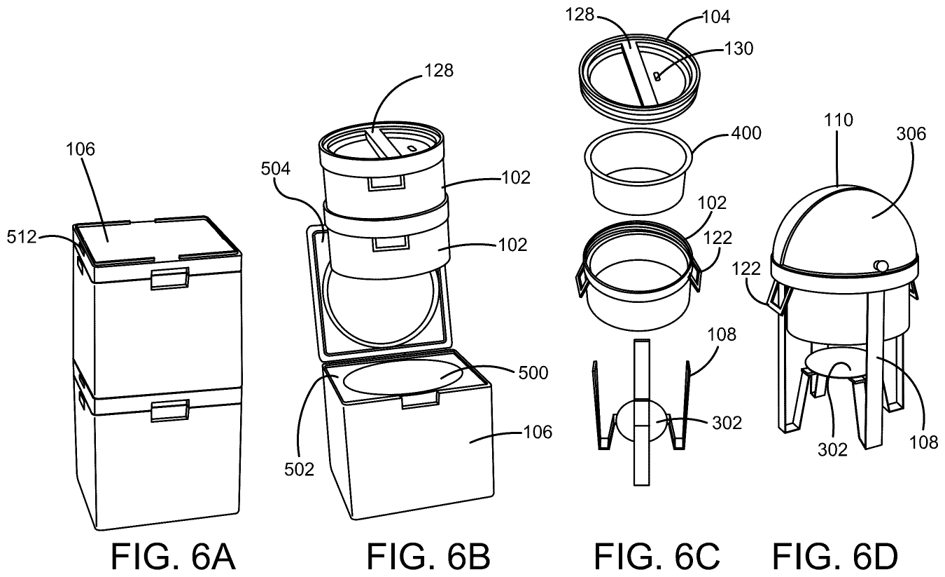

As shown in FIGS. 6A-D and 7, the chafing dish device 100 comprises removable inserts and secure lids, allowing the device 100 to be modular and easily transportable. In operation, the liquid food is inserted into the base component 102 and secured with the screw-top lid 104. The base component 102 with secured lid 104 is then positioned within the insulated crates 106 and transported. Once transported, the base component 102 is positioned on the leg supports 108 at the serving station and the screw-top lid 104 is removed and replaced with the serving lid 110. Thus, the variable inserts and lids make it fast and easy to set up serving stations and provide elegant serving options that can blend with any event décor.

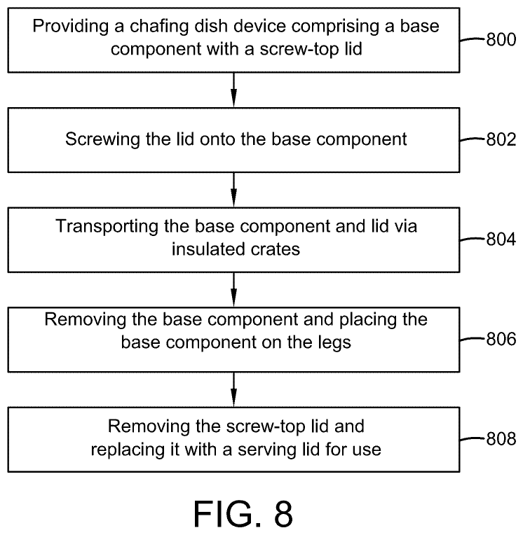

FIG. 8 illustrates a flowchart of the method of easily transporting liquid food without spills. The method includes the steps of at 800, providing a chafing dish device comprising a base component with a screw-top lid. The method also comprises at 802, screwing the lid onto the base component. Further, the method comprises at 804, transporting the base component and lid via insulated crates. The method also comprises at 806, removing the base component and placing the base component on the legs. Finally, the method comprises at 808, removing the screw-top lid and replacing it with a serving lid for use.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “chafing dish device”, “chafing device”, and “device” are interchangeable and refer to the chafing dish device 100 of the present invention.

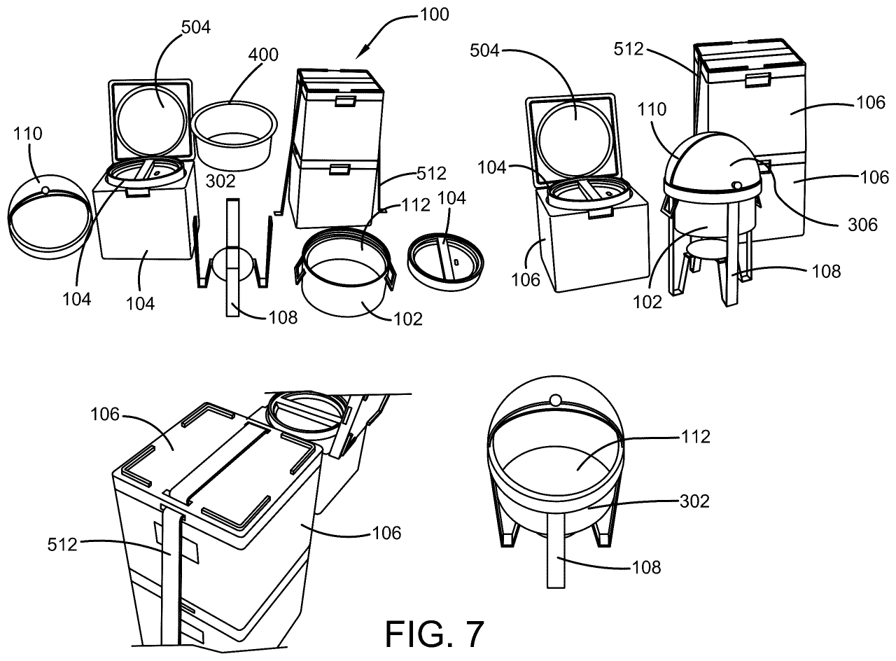

Notwithstanding the forgoing, the chafing dish device 100 of the present invention can be of any suitable size and configuration as is known in the art without affecting the overall concept of the invention, provided that it accomplishes the above stated objectives. One of ordinary skill in the art will appreciate that the chafing dish device 100 as shown in FIGS. 1-8 is for illustrative purposes only, and that many other sizes and shapes of the chafing dish device 100 are well within the scope of the present disclosure. Although the dimensions of the chafing dish device 100 are important design parameters for user convenience, the chafing dish device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A chafing dish device that provides a user with a means for transporting liquid foods without spillage, the chafing dish device comprising:
a base component; and
a screw-top lid; and
wherein the screw-top lid secures onto the base component to prevent spills and leaks;
wherein the base component and the screw-top lid are easily transportable in a stacking crate; and
further wherein the base component is removed from the stacking crate and placed on legs for serving at a serving station.

2. The chafing dish device of claim 1, wherein the base component is configured in a round shape with an open interior cavity.

3. The chafing dish device of claim 2, wherein the base component is large enough to fit up to approximately nine quarts of food.

4. The chafing dish device of claim 3, wherein the base component comprises a bottom surface, with a curved side wall and an open top surface which allows access to the open interior cavity.

5. The chafing dish device of claim 4, wherein the curved side wall comprises an upper interior threaded perimeter which mates with the screw-top lid.

6. The chafing dish device of claim 5, wherein the base component comprises folding handles for easy transportation.

7. The chafing dish device of claim 6, wherein the screw-top lid comprises external threads which mate with the upper interior threaded perimeter of the base component.

8. The chafing dish device of claim 7, wherein the screw-top lid comprises a raised component which bisects a top to create a handle, allowing a user to easily rotate the screw-top lid on and off, as needed.

9. The chafing dish device of claim 8, wherein the screw-top lid includes a pressure release valve and a tight seal.

10. The chafing dish device of claim 9, wherein the base component is nested within the legs during serving.

11. The chafing dish device of claim 10, wherein the legs are secured to an elevated section which holds the fuel for the base component.

12. The chafing dish device of claim 11, wherein the screw-top lid is replaced with a serving lid for serving.

13. The chafing dish device of claim 12, wherein the serving lid is a domed configuration with a retractable section, which can be raised and lowered, as needed to access liquid food inside the base component.

14. The chafing dish device of claim 13 further comprising an aluminum liner that fits within the base component and is removable for easy cleaning.

15. A chafing dish device that provides a user with a means for transporting liquid foods without spillage, the chafing dish device comprising:
a base component configured in a round shape with an open interior cavity and interior threads; and
a screw-top lid with external threads which mate with the interior threads; and
wherein the screw-top lid secures onto the base component to prevent spills and leaks;
wherein the screw-top lid comprises a raised component which bisects a top to create a handle, allowing a user to easily rotate the screw-top lid on and off, as needed;
wherein the screw-top lid includes a pressure release valve and a tight seal;
wherein the base component and the screw-top lid are easily transportable in a stacking crate;
wherein the base component is removed from the stacking crate and placed on legs for serving at a serving station;
wherein the legs are secured to an elevated section which holds the fuel for the base component;
wherein the screw-top lid is replaced with a serving lid, which is a domed configuration with a retractable section, which can be raised and lowered, as needed to access liquid food inside the base component; and
further wherein the base component includes an aluminum liner that is removable for easy cleaning.

16. The chafing dish device of claim 15 further comprising a plurality of indicia.

17. The chafing dish device of claim 15, wherein the stacking crate is configured in a cube-like shape with an open interior cylindrical cavity, sized and shaped to retain the base component.

18. The chafing dish device of claim 17, wherein an interior of the stacking crate is filled with insulating materials which keep the liquid food within the base component hot or cold, depending on a need.

19. The chafing dish device of claim 18, wherein the stacking crate includes a hinged lid with a seal and latch, and tie-down channels on opposing sides, which allow the stacking crate to be tied-down and secured during transportation and storage.

20. A method of easily transporting liquid food without spills, the method comprising the following steps:
providing a chafing dish device comprising a base component with a screw-top lid;
screwing the lid onto the base component;
transporting the base component and lid via insulated crates;
removing the base component and placing the base component on the legs; and
removing the screw-top lid and replacing it with a serving lid for use.
